(19) United States
(12) Patent Application Publication
(10) Pub. No.: US 2010/0036701 A1
(43) Pub. Date: Feb. 11, 2010

(54) Physician And Medical Vender Appointment Coordination Method

(76) Inventor: Parran Foster, Waldorf, MD (US)

Correspondence Address: Lauson & Tarver LLP, 880 Apollo Street, SUITE 301, El Segundo, CA, 90245, US

(21) Appl. No.: 12/187,350

(22) Filed: Aug. 6, 2008

(51) Int. Cl. G06Q 10/00; G06Q 20/00

(52) U.S. Cl. 705/8

(57) ABSTRACT

A system and method of organizing appointments between physicians and venders of medical products and services, involving the steps of hosting an Internet based protocol that allows physicians to create an ID and input available appointment information from their office calendars, allowing venders to create an ID, input payment information, and select individual available appointments with physicians; wherein the system manages appointments and payments through a series of protocols governing the conditions under which payments for appointments are collected or forfeited.

### CROSS-REFERENCE TO RELATED APPPLICATION

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

As rising healthcare costs place time constraints on physicians, medical venders frequently make personal calls to physician offices to introduce new information about products or services. These visits are necessary to keep physicians informed of new medical developments; however, no effective system currently exists to organize and manage these visits, resulting in wasted time since venders miss appointments, visit randomly, and due to redundant visits by multiple venders. Therefore there is a need for a system that efficiently and accurately organizes marketing visits to physician offices, and which also compensates physicians for their time.

U.S. Pat. No. 6,961,418 to Thygeson, et al discloses a system wherein appointments for a professional are captured and placed on an “electronic” waiting list (e.g., database of scheduled appointments) in an appointment system. When available, the professional (e.g., a physician) communicates with the appointment system and announces his availability. The appointment system begins contacting individuals (e.g., patients) on the waiting list (e.g., in an order specified by the professional), and then bridges the physician and patient for the appointment. The communications are preferably telephone calls, but may be telephone, electronic chats, e-mail, pages, etc. The appointment system includes a billing interface that charges the patient/patients insurance for the appointment. The Appointments themselves may be scheduled, for example, via a touch tone phone response system, a web interface, or other communication devices, etc.

Although Thygeson discloses a system for managing appointments, it does not take into account doctor visits by non-patients and venders of medical products and services in particular. Furthermore, the instant invention does not require individual contact by the system nor does it maintain a waiting list for appointments. Instead, the present system allows physicians to set availability according to their own calendars, and then allows venders to select and pay for available appointment times; in addition to using protocols for preventing missed appointments, redundant visits, and situations wherein products are marketed to physicians outside their field of expertise.

It is therefore an object of the present invention to provide an improved system of organizing and scheduling meetings between physicians and venders of medical products and services. A further object of the present invention is to provide a single point of contact wherein physician's calendar availability is posted and venders can buy available time segments purchased by the system from physicians who are then ultimately compensated for their time. A further object of the present invention is to provide protocols in the system, whereby protocols are set up to regulate payments and payment forfeitures according to whether appointments are kept or missed.

### SUMMARY

An improved system and method of providing access to physicians by medical venders is herein disclosed comprising a system of organizing access to physicians, and compensating physicians for their time. Physicians enroll in the system free of charge, and provide a schedule of 5 minute time segments determined from their personal office calendars to meet with medical venders to discuss medical products and services, wherein venders pay for the meetings online.

The system further comprises a database providing a single point of contact where physician calendars are maintained and displayed, and allowing venders to make and pay for new appointments. The database regulates appointments according to a protocol governing the length and frequency of appointments, tracks fee forfeitures and allocates refunds into an online bank based on established appointment rules.

Physicians and vendors enroll in the system, an Internet based website. Physicians create a secure user ID, and provide information related to their specialties and contact information. Venders also create a secure user ID, and provide information regarding corporate affiliation and contact information. Vendors may pay an initial fee for enrollment in the system.

Enrolled physicians consult their private office calendars, and select times they will be available for appointments with venders. Once these times are identified, they may input this information into the system, which will maintain a calendar of availability for all participating physicians and venders. Venders may consult the identities and specializations of physicians who may be interested in the goods and services offered by a vender. The system posts physician availability, including a search feature that allows vendors to seek out physicians according to search parameters. Venders may consult the identities and specializations of physicians who may be interested in the goods and services offered by a vender. Time periods already selected for appointments may be blocked off and are invisible so that only available appointments are shown.

When a time segment is selected, the vendor is prompted to pay for the appointment at that time. Protocols are set up that govern the duration, frequency and timing of appointments, including appointments comprising five minute time periods, consecutive appointment frequency, and a protocol allowing vender representatives to cancel appointments up to a predetermined time prior to the appointment for a refund, after which the appointment fee is forfeited, including forty eight hours prior to an appointment, an additional protocol governing the grace period beyond which appointment fees will be forfeited, including a five minute grace period, and a protocol governing circumstances wherein the physician is unable to keep an appointment and is therefore not entitled to the fee. Fees that are returned due to a physician's inability to meet with a vendor are banked and maintained in the vendor's account within the system. Fees earned for successful meetings by a physician during the previous month are paid by check within the first 20 days of the succeeding month.

When appointments are missed by a vender or physician, the appointment fee will either be paid to the physician or refunded to the vendor, including reimbursement to a vender account.

### FIGURES

FIG. 1 is a diagram of the method of the present invention, showing the steps involved in executing the system.

### DESCRIPTION

An improved system and method of providing access to physicians by medical venders is herein disclosed and described. The method comprises a system of regulating access to physicians, and compensating physicians for their time in a manner that permits physicians to enroll in the system free of charge, and make themselves available, according to their individual office calendars, to meet with medical venders for the purposes of discussing venders' products and services, wherein the venders purchase time segments set aside for the meetings. The types of meetings anticipated by the system include in-person office visits by venders for the purpose of marketing their products or services via formal presentations; therefore, vender representatives delivering samples, and representatives responding to physician requests for visits are outside the scope of the system.

The system further comprises a coordinated database that allows physicians and venders to enroll in the system, the database comprising a single point of contact wherein individual physician calendars and appointment availability are maintained, with the capability of allowing venders to make and pay for new appointments, and regulate appointments according to a protocol governing the length and frequency of appointments, and allocating fee forfeitures and refunds based on established program policies.

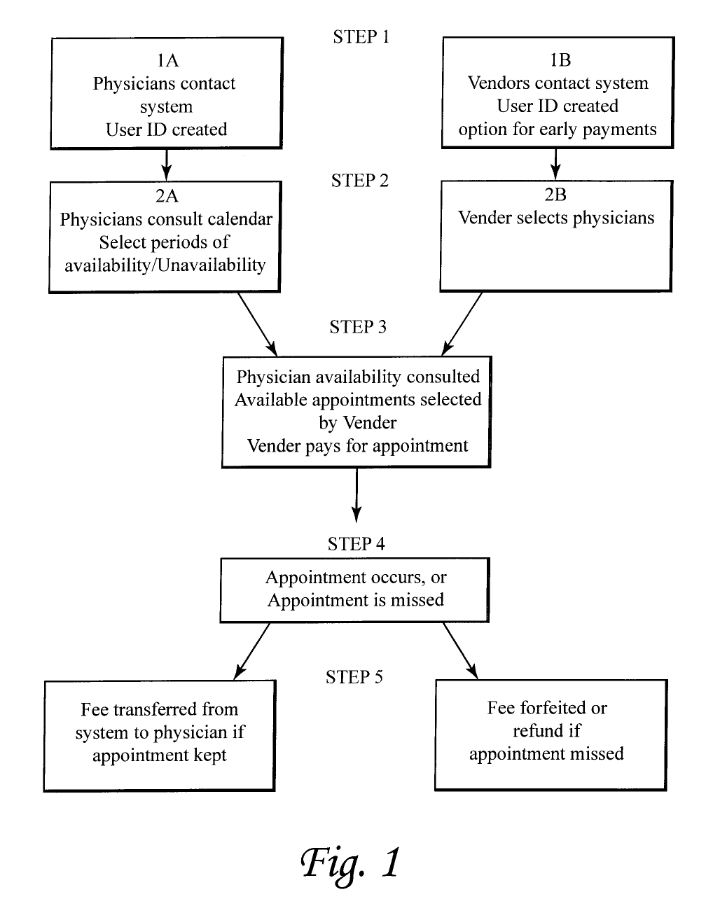

Referring to FIG. 1, the method and system of the present invention is shown and described. Referring to Step 1, of the system, participating physicians 1A and participating vendors 1B enroll in the system. In one preferred embodiment of the invention, the system comprises an Internet based, including web hosted site where new users can enroll as physicians and venders. Physicians can create a secure user ID, and may include information indicating the types of services they provide, including biographical information. Venders can create a secure user ID, and may include information regarding their products and services. In one preferred embodiment of the invention, vendors pay an initial fee for enrollment in the system. In another preferred embodiment, IDs may be PIN number protected.

Referring to Step 2A, once enrolled, physicians may consult their own office calendars, and select the times they will be available for appointments with venders. Once these times are identified, they may input this information into the system, including the webpage of the system, which will maintain a calendar of availability for all participating physicians. In one preferred embodiment, the physician's staff will be able to register periods of unavailability with the system to account for blocks of time wherein the physician is unavailable.

Referring to FIG. 2B, once enrolled, venders may consult the identities and specializations of physicians who, based on their stated areas of expertise, may be interested in the goods and services offered by a vender.

Referring to Step 3, the system posts the availability of participating physicians, including a search feature that allows vendors to seek out physicians according to a variety of parameters. Time periods already selected for appointments are blocked off and invisible to vendors so that only available appointment times are shown.

At this stage, when an available appointment is selected, the vendor is prompted to pay for the appointment. Venders can then check the availability of the physicians in question, and when an appointment is selected, the vendor pays for the appointment. In an alternative embodiment, vendors may maintain accounts in the system that allow them to pay fees in advance, and when appointments are selected, individual charges are made to the vendor account.

Referring to Step 4, the appointment is either kept by the parties, or fails to occur on the account of either the physician or the vendor. In various alternative embodiments, protocols are set up that govern the duration, frequency and timing of appointments. These embodiments can include: Appointments comprising five minute time periods, wherein multiple consecutive appointments may be allowed or not allowed according to the internal rules of the system, or according to protocols set by individual physicians; appointment frequency rules permitting appointments made up to seventy five days in advance of a scheduled office visit, and only permitting a predetermined number of appointments within a predetermined time, including one appointment every thirty days; a protocol allowing vender representatives to cancel appointments up to a predetermined time prior to the appointment for banking, after which the appointment fee is forfeited, including forty eight hours prior to an appointment; and a protocol governing the grace period after a scheduled appointment beyond which appointment fees will be forfeited, including a five minute grace period; finally, protocol governing physicians may also be a part of the system. In particular, a rule governing the period of time after an appointment is scheduled, beyond which an appointment is determined to be cancelled, including twenty minutes after the scheduled commencement of an appointment. Fees that are no longer collectable by physicians are banked for the representative and maintained within the system.

In one preferred embodiment, the physician's staff will monitor the timing of appointments, and whether appointments are kept or missed, and will report these events to the system. In a further preferred embodiment, venders can enter information regarding representatives and their supervisors into the system, wherein physician staff can access the supervisor of a non-appearing representative after an appointment is missed.

Referring to Step 5A, in a preferred embodiment of the system, payment for all of the previous months successful contacts will be made according to a payment schedule, including payments made by check within the first 20 days of the new month to compensate physicians.

Referring to Step 5B, when appointments that are missed by a vender or physician, the appointment fee will either be paid to the physician or refunded to the vendor, including reimbursement to a vendor account within the system, according to the protocols of Step 4. As previously mentioned, the physician's staff may monitor events and register kept and missed appointments and the identity of the responsible party within the system. In a further preferred embodiment, the data gathered during Step 5 may be used by the system to generate reports regarding the total number of missed and kept appointments by both venders and physicians, in order to administer enrollment privileges in the system.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An improved system and method of providing access to physicians by medical venders, comprising the steps of;
a. purchasing time segments from physicians, wherein the time segments correspond to appointments of a specified period for meeting with a physician;
b. offering the segments individually or in multiples for sale to parties targeting those physicians for marketing presentations; and
c. establishing an Internet based program that acts as a control point for physicians and parties, wherein the program organizes all scheduling and allocating of time segments and transactions between the physicians and the parties governed by predetermined policies.

2. The system of claim 1, wherein the system is administered by an automatic program, including an Internet based program that can be accessed by participating physicians and venders.

3. The system of claim 2, wherein physicians and venders can access the program to create a profile corresponding to their identity, including a secure profile, including a PIN number protected profile.

4. The system of claim 3, wherein venders can access the program to identify specific physicians and corresponding periods of availability; make payments into the system; and schedule appointments with physicians.

5. The system of claim 2, wherein the program comprises a monitoring system from which reports can be generated to manage physician and vender accounts, and administer policies of the system.

6. The system of claim 2, wherein the program allows venders to pay fees for and make appointments, automatically transferring fees or a portion of a fee to an account specified by the physician.

7. The system of claim 1, wherein physicians use their individual office calendars to provide information comprising time periods they will be available for a meeting.

8. The system of claim 7, wherein each time period comprises a five minute increment of time.

9. The system of claim 7, wherein physicians use their individual office calendars to block dates of unavailability.

10. The system of claim 2, wherein only available time periods are viewable, including selectable by a vender, and all other times are unknown or invisible.

11. The system of claim 1, wherein the physician's office staff monitors the system, including notification when a physician or vender misses an appointment.

12. The system of claim 1, wherein specific time periods are established to govern;
a. the maximum amount of time permissible between scheduling an appointment and the appointment date;
b. The maximum amount of time prior to an appointment when the appointment can be cancelled for a refund to the vender.
c. The maximum amount of time, or grace period, allowed after a scheduled appointment before the vender fee is forfeited.
d. The maximum amount of time allowed prior to an appointment that a physician may cancel an appointment.

13. The system of claim 1, wherein payments to physicians may be made by a physical or electronic funds transfer.

14. The system of claim 1, wherein a specified amount of time is established between an appointment and payment made to a physician by the system.

15. The system of claim 1, wherein appointments can be made up to seventy five days in advance.

16. The system of claim 1, wherein appointments must be made at least thirty days apart.

17. The system of claim 1, wherein an appointment may be cancelled up to 48 hours in advance, wherein vender fees will be refunded.

18. The system of claim 1, wherein after a grace period of five minutes, an appointment is considered missed and vender and fees are forfeited.

19. The system of claim 1, wherein a physician that fails to meet a vender within 20 minutes of a scheduled appointment, the appointment is cancelled and fees are refunded to the vender.

20. An improved system and method of providing access to physicians by medical venders, comprising;
a. establishing an enrollment process that allows physicians to enroll in the system by identifying themselves, including the creation of a secure profile accessible by a PIN number;
b. establishing an enrollment process that allows venders of medial products and services to identify themselves including the creation of a secure profile accessible by a PIN number;
c. establishing time segments comprising five minute appointments, designed for the interaction of an enrolled physician with an enrolled medical vender, wherein vendors pay for time segments at a predetermined amount.
d. establishing an Internet based protocol that allows enrolled physicians to designate periods of availability and allows enrolled venders to purchase time segments, and wherein the time segments correspond to available appointments with physicians; and
e. establishing and administering a protocol that allows venders to purchase specific time segments, wherein at least some portion of the purchase price is transmitted to a physician, each time segment corresponds to an appointment with a specific enrolled physician to offer products and services; and wherein once a time segment is purchased, that segment is no longer available to other vendors.
